(19) United States
(12) Patent Application Publication
(10) Pub. No.: US 2010/0097587 A1
(43) Pub. Date: Apr. 22, 2010

(54) LITHOGRAPHIC APPARATUS AND A METHOD OF REMOVING CONTAMINATION

(75) Inventors: Anthonius Martinus Cornelis Petrus De Jong, Pijnacker (NL); Hans Jansen, Eindhoven (NL); Jacques Cor Johan Van Der Donck, Alphen aan den Rijn (NL); Harrie Gorter, Eindhoven (NL); Johannes Hendrik Van Der Berg, Den Haag (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/582,214

(22) Filed: Oct. 20, 2009

Related U.S. Application Data
(60) Provisional application No. 61/193,003, filed on Oct. 21, 2008.

(51) Int. Cl. G03B 27/52

(52) U.S. Cl. 355/30

(57) ABSTRACT

A lithographic apparatus includes a fluid supply system configured to provide a cleaning fluid to a surface to be cleaned. The cleaning fluid includes from 25 to 98.99 wt % water; from 1 to 74.99 wt % solvent selected from one or more glycol ethers, esters, alcohols and ketones; and from 0.01 to 5 wt % surfactant.

### CROSS-REFERENCE TO RELATED APPLICATIONS

This application claims the benefit of priority from U.S. Provisional Patent Application No. 61/193,003, filed on Oct. 21, 2008, the entire content of which is incorporated herein by reference.

### FIELD

The present invention relates to a lithographic apparatus and a method of removing contamination in a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the present invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example, U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion liquid is handled by a fluid handling system or apparatus. In an embodiment the fluid handling system may supply immersion fluid and therefore be a fluid supply system. In an embodiment the fluid handling system may confine fluid and thereby be a fluid confinement system. If the confined fluid is a liquid, the fluid confinement system may have a liquid confinement structure. In an embodiment the fluid handling system may provide a barrier to fluid and thereby be a barrier member. In an embodiment the fluid handling system may create or use a flow of fluid (such as gas), for example to help in handling liquid such as to confine liquid for example as a contactless gas seal. In an embodiment, immersion liquid may be used as the immersion fluid. In that case, the fluid handling system may be a liquid handling. One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT Patent Application Publication No. WO 99/49504. The liquid can enter and leave the system through one or more openings. The openings through which the fluid enters the system can be designated as inlets and the openings through which the liquid leaves the system can be designated as outlets. As illustrated in FIGS. 2 and 3, liquid is supplied by at least one inlet onto the substrate, desirably along the direction of movement of the substrate relative to the final element. Liquid is removed by at least one outlet after having passed under the projection system. That is, as the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element. Note that the direction of flow of the liquid is shown by arrows in FIGS. 2 and 3.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets and can be arranged in a plate with a hole in its center and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). Note that the direction of flow of fluid and of the substrate W is shown by arrows in FIG. 4.

Another arrangement which has been proposed is to provide the liquid supply system with a liquid confinement member which extends along at least a part of a boundary of the space between the final element of the projection system and the substrate table. Such an arrangement is illustrated in FIG. 5. The liquid confinement member is substantially stationary relative to the projection system in the XY plane though there may be some relative movement in the Z direction (in the direction of the optical axis). A seal is formed between the liquid confinement and the surface of the substrate. In an embodiment, a seal is formed between the liquid confinement structure and the surface of the substrate and may be a contactless seal such as a gas seal. Such a system is disclosed in United States Patent Application Publication No. US 2004-0207824, hereby incorporated in its entirety by reference.

In European Patent Application Publication No. 1420300 and United States Patent Application Publication No. 2004-0136494, each hereby incorporated in its entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

PCT Patent Application Publication WO 2005/064405 discloses an all wet arrangement in which the immersion liquid is unconfined. In such a system the whole top surface of the substrate is covered in liquid. This may be advantageous because then the whole top surface of the substrate is exposed to the substantially same conditions. This has an advantage for temperature control and processing of the substrate. In WO 2005/064405, a liquid supply system provides liquid to the gap between the final element of the projection system and the substrate. That liquid is allowed to leak over the remainder of the substrate. A barrier at the edge of a substrate table prevents the liquid from escaping so that it can be removed from the top surface of the substrate table in a controlled way. Although such a system improves temperature control and processing of the substrate, evaporation of the immersion liquid may still occur. One way of helping to alleviate that problem is described in United States Patent Application Publication No. 2006/0119809. A member is provided which covers the substrate W in all positions and which is arranged to have immersion liquid extending between it and the top surface of the substrate and/or substrate table which holds the substrate.

One potential problem encountered with lithographic machines is the occurrence of contaminating particles within the system and on the surface of the substrate. The presence of a particle in the system may cause a defect to occur during the exposure process, for example, if a particle is present between a projection system and a substrate being exposed. Contamination may deleteriously affect performance, for example, of a fluid containment system. It is therefore desirable to reduce the presence of contaminating particles. Thus a cleaning system in a lithographic machine is desirable. Cleaning can be problematic because of the incompatibility of certain cleaning fluids with lens and other optical coatings.

Previously, cleaning of surfaces in a lithographic apparatus has been performed with ultra pure water (UPW), detergents such as TLDR-A0001, or using substances such as hydrogen peroxide. However, these agents may not always effectively clean to the desired degree. Embodiments of the present invention provide cleaning fluids which can effectively clean the surfaces of the lithographic apparatus.

### SUMMARY

It is desirable to provide a system for cleaning a surface in a lithographic apparatus.

According to an aspect of the invention, there is provided a lithographic apparatus comprising a projection system configured to project a patterned beam of radiation onto a target portion of a substrate, and a fluid supply system configured to provide a cleaning fluid to a surface to be cleaned. The cleaning fluid comprises: from 25 to 98.99 wt % water; from 1 to 74.99 wt % solvent selected from one or more glycol ethers, esters, alcohols and ketones; and from 0.01 to 5 wt % surfactant.

According to an aspect of the invention, there is provided a method of cleaning a surface in a lithographic apparatus. The method comprises supplying a cleaning fluid to the surface to be cleaned. The cleaning fluid comprises: from 25 to 98.99 wt % water; from 1 to 74.99 wt % solvent selected from one or more glycol ethers, esters, alcohols and ketones; and from 0.01 to 5 wt % surfactant.

According to an aspect of the invention, there is provided the use of a cleaning fluid to clean a lithographic apparatus.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a fluid handling structure as a liquid supply system for use in a lithographic projection apparatus;

FIG. 4 depicts a further liquid supply system for use in a lithographic projection apparatus;

FIG. 5 depicts, in cross-section, a barrier member which may be used in an embodiment of the present invention as a liquid supply system;

FIG. 6 illustrates, in cross-section, another barrier member which may be used in an embodiment of the present invention;

FIG. 7 depicts the experimental set up used to mimics the streaming behavior in the immersion hood;

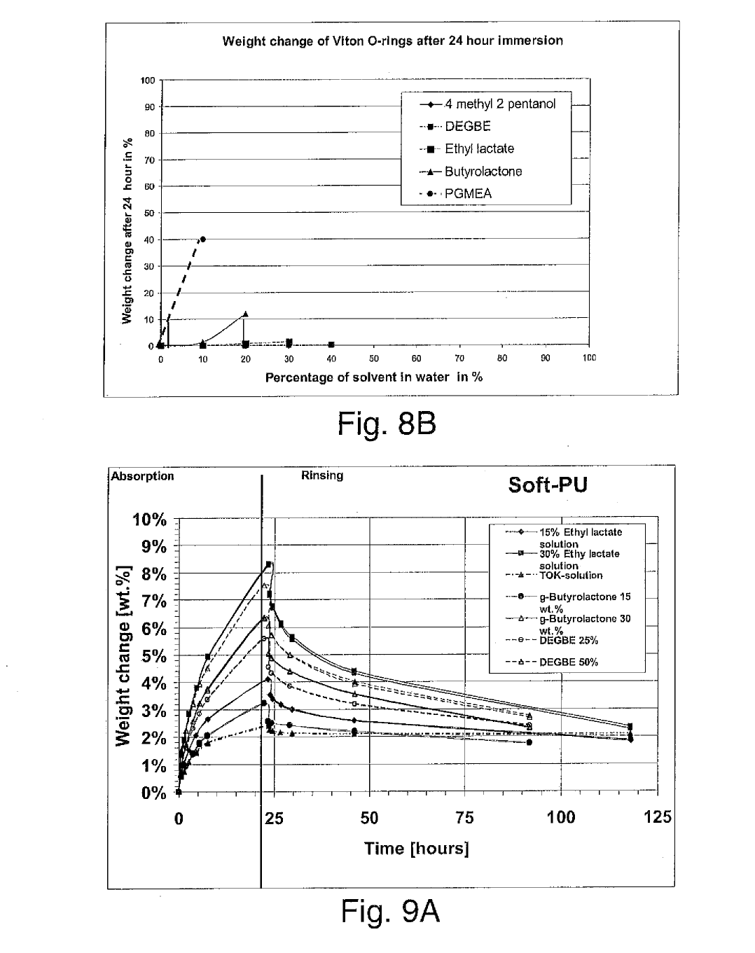

FIG. 5A is a graph showing the weight change for soft polyurethane (PUR) tubing after immersion for 24-hours in different solvents;

FIG. 8B is a graph showing the weight change for Viton O-rings after immersion for 24-hours in different solvents;

FIG. 9A depicts absorption and desorption over time for soft polyurethane exposed to different solvents;

FIG. 9B depicts absorption and desorption over time for Viton exposed to different solvents;

FIG. 10 depicts TOC levels in PFA and Fluran tubing exposed to a cleaning fluid and then rinsed; and

FIG. 11 depicts SEM microscopy pictures of lens coatings: polyurethane-based coating at the start of the experiment (top left); UPW exposed polyurethane-based coating (middle left); DEGBE exposed polyurethane-based coating (bottom left), SiOₓC_{y}H_{z} coating at the start of the experiment (top right); UPW exposed SiOₓC_{y}H_{z} coating (middle right). DEGBE exposed SiOₓC_{y}H_{z} coating (bottom right).

### DETAILED DESCRIPTION

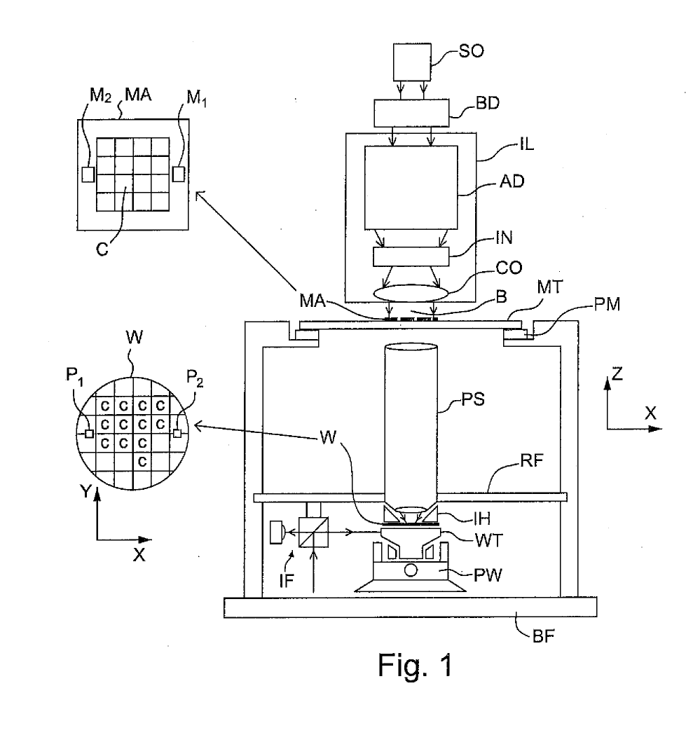

FIG. 1 schematically depicts a lithographic apparatus according to one embodiment of the invention. The apparatus comprises an illumination system (illuminator) IL configured to condition a radiation beam B (e.g. UV radiation or DUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device. The support structure MT holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as required. The support structure MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system. The types of projection system may include: refractive, reflective, catadioptric, magnetic, electromagnetic and electrostatic optical systems, or any combination thereof. The selection or combination of the projection system is as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AM for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS. The projection system focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

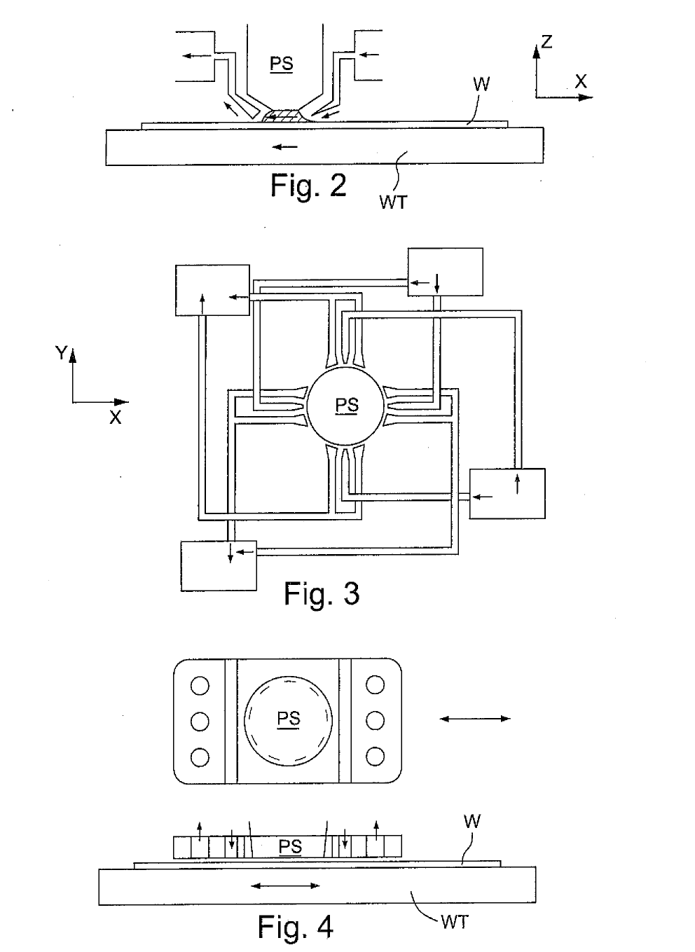

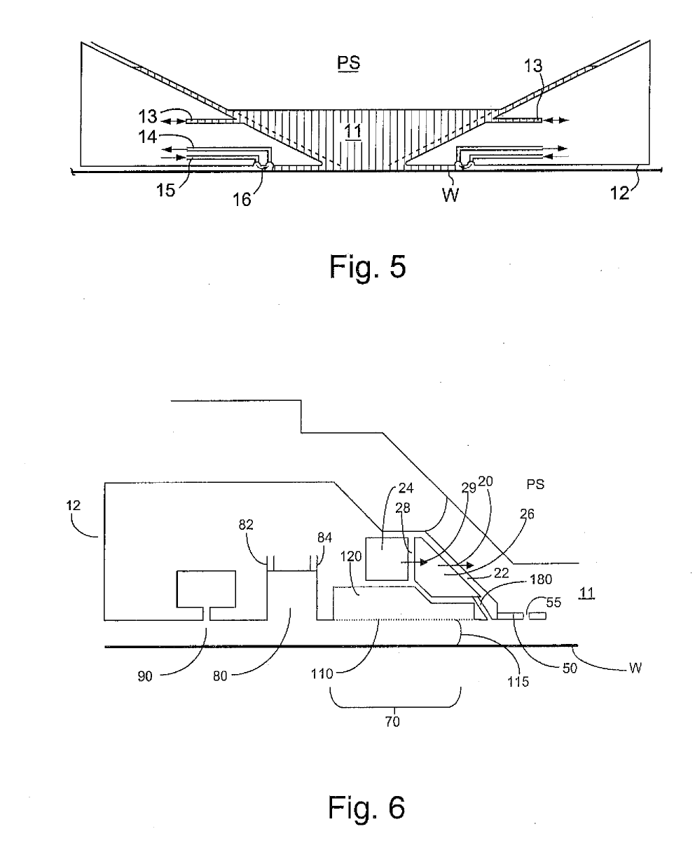

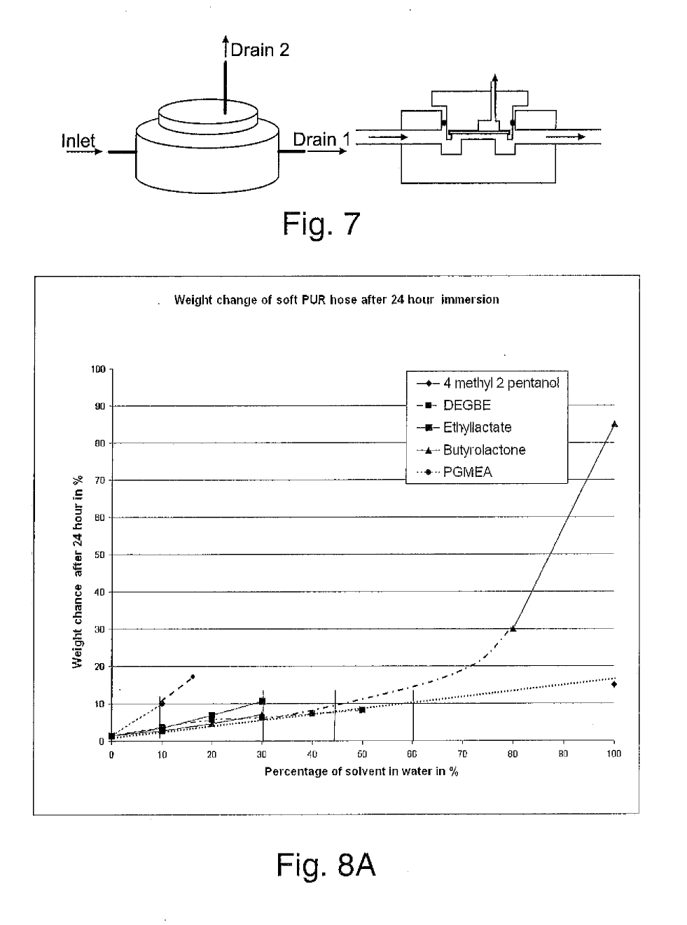

An arrangement for providing liquid between a final element of the projection system PS and the substrate is the so called localized immersion system. In this system a liquid handling system (represented by IH in FIG. 1) is used in which liquid is only provided to a localized area of the substrate. The space filled by liquid is smaller in plan than the top surface of the substrate and the area filled with liquid remains substantially stationary relative to the projection system PS while the substrate W moves underneath that area. Four different types of localized liquid supply systems are illustrated in FIGS. 2-5. The liquid supply systems disclosed in FIGS. 2-4 were described above.

FIG. 5 schematically depicts a localized liquid supply system with a barrier member 12. The barrier member extends along at least a part of a boundary of the space between the final element of the projection system and the substrate table WT or substrate W. (Please note that reference in the following text to surface of the substrate W also refers in addition or in the alternative to a surface of the substrate table, unless expressly stated otherwise.) The barrier member 12 is substantially stationary relative to the projection system in the XY plane though there may be some relative movement in the Z direction (in the direction of the optical axis). In an embodiment, a seal is formed between the barrier member and the surface of the substrate W and may be a contactless seal such as fluid seal, desirably a gas seal.

The barrier member 12 at least partly contains liquid in the space 11 between a final element of the projection system PS and the substrate W. A contactless seal 16 to the substrate W may be formed around the image field of the projection system so that liquid is confined within the space between the substrate W surface and the final element of the projection system PS. The space is at least partly formed by the barrier member 12 positioned below and surrounding the final element of the projection system PS. Liquid is brought into the space below the projection system and within the barrier member 12 by liquid inlet 13. The liquid may be removed by liquid outlet 13. The barrier member 12 may extend a little above the final element of the projection system. The liquid level rises above the final element so that a buffer of liquid is provided. In an embodiment, the barrier member 12 has an inner periphery that at the upper end closely conforms to the shape of the projection system or the final element thereof and may, e.g., be round. At the bottom, the inner periphery closely conforms to the shape of the image field, e.g., rectangular, though this need not be the case.

In an embodiment, the liquid is contained in the space 11 by a gas seal 16 which, during use, is formed between the bottom of the barrier member 12 and the surface of the substrate W. The gas seal is formed by gas, e.g. air or synthetic air but, in an embodiment, N₂ or another inert gas. The gas in the gas seal is provided under pressure via inlet 15 to the gap between barrier member 12 and substrate W. The gas is extracted via outlet 14. The overpressure on the gas inlet 15, vacuum level on the outlet 14 and geometry of the gap are arranged so that there is a high-velocity gas flow 16 inwardly that confines the liquid. The force of the gas on the liquid between the barrier member 12 and the substrate W contains the liquid in a space 11. The inlets/outlets may be annular grooves which surround the space 11. The annular grooves may be continuous or discontinuous. The flow of gas 16 is effective to contain the liquid in the space 11. Such a system is disclosed in United States Patent Application Publication No. 2004-0207824.

Other arrangements are possible and, as will be clear from the description below, an embodiment of the present invention may use any type of localized liquid supply system as the liquid supply system.

One or more localized liquid supply systems seal between a part of the liquid supply system and a substrate W. The seal may be defined by a meniscus of liquid between the part of the liquid supply system and the substrate W. Relative movement of that part of the liquid supply system and the substrate W may lead to breakdown of the seal, for example the meniscus, and thereby leaking of liquid. The problem may be more significant at high scan velocities. An increased scan velocity is desirable because throughput increases.

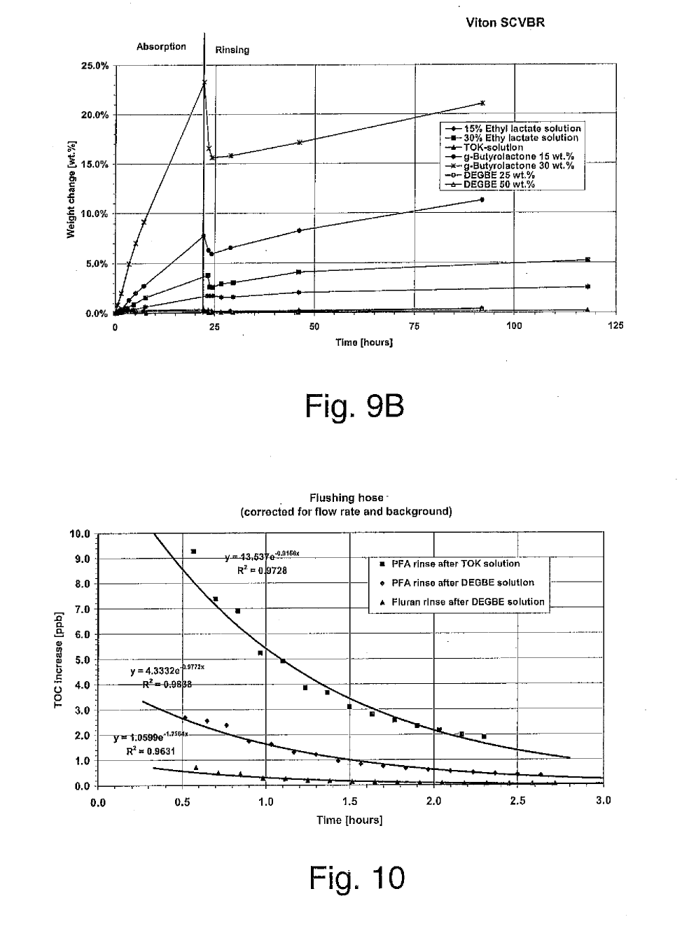

FIG. 6 illustrates a barrier member 12 which is part of a liquid supply system. The barrier member 12 extends around the periphery (e.g., circumference) of the final element of the projection system PS such that the barrier member (which is sometimes called a seal member) is, for example, substantially annular in overall shape. The projection system PS may not be circular and the outer edge of the barrier member 12 may also not be circular so that it is not necessary for the barrier member to be ring shaped. The barrier could also be other shapes so long as it has an opening through which the projection beam may pass out from the final element of the projection system PS. The opening may be centrally located. Thus, during exposure, the projection beam may pass through liquid contained in the opening of the barrier member and onto the substrate W. The barrier member 12 may be, for example, substantially rectangular and may not be necessarily the same shape as the final element of the projection system PS is at the height of the barrier member 12.

The function of the barrier member 12 is at least partly to maintain or confine liquid in the space between the projection system PS and the substrate W so that the projection beam may pass through the liquid. The top level of liquid is simply contained by the presence of the barrier member 12. The level of liquid in the space is maintained such that the liquid does not overflow over the top of the barrier member 12.

The immersion liquid is provided to the space 11 by the barrier member 12 (thus the barrier member may be considered to be a fluid handling structure). A passageway or flow path for immersion liquid passes through the barrier member 12. Part of the flow path is comprised by a chamber 26. The chamber 26 has two side walls 28, 22. Liquid passes through the first side wall 28 into chamber 26 and then through the second side wall 22 into the space 11. A plurality of outlets 20 provide the liquid to the space 11. The liquid passes through through holes 29, 20 in plates 28, 22 respectively prior to entering the space 11. The location of the through holes 20, 29 may be random.

A seal is provided between the bottom of the barrier member 12 and the substrate W (This feature indicates that the barrier member may be a fluid handling structure). In FIG. 6 a seal device is configured to provide a contactless seal and is made up of several components. Radially outwardly from the optical axis of the projection system PS, there is provided a (optional) flow plate 50 which extends into the space (though not into the path of the projection beam) which helps maintain substantially parallel flow of the immersion liquid out of outlet 20 across the space. The flow control plate has through holes 55 in it to reduce the resistance to movement in the direction of the optical axis of the barrier member 12 relative to the projection system PS and/or substrate W.

Radially outwardly of the flow control plate 50 on the bottom surface of the barrier member 12 may be an inlet 180. The inlet 180 can provide liquid in a direction towards the substrate. During imaging this may be useful in preventing bubble formation in the immersion liquid by filling a gap between the substrate W and substrate table WT with liquid.

Radially outwardly of the inlet 180 may be an extractor assembly 70 to extract liquid from between the barrier member 12 and the substrate W and/or the substrate table WT. The extractor 70 will be described in more detail below and forms part of the contactless seal which is created between the barrier member 12 and the substrate W. The extractor may operate as a single phase or as a dual phase extractor.

Radially outwardly of the extractor assembly 70 may be a recess 80. The recess is connected through an inlet 82 to the atmosphere. The recess is connected via an outlet 84 to a low pressure source. The inlet 82 may radially outwardly positioned with respect to the outlet 84. Radially outwardly of the recess 80 may be a gas knife 90. An arrangement of the extractor, recess and gas knife is disclosed in detail in United States Patent Application Publication No. 2006/0158627. However, in that document the arrangement of the extractor assembly is different.

The extractor assembly 70 comprises a liquid removal device or extractor or inlet such as the one disclosed in United States Patent Application Publication No. 2006-0038968, incorporated herein its entirety by reference. Any type of liquid extractor may be used. In an embodiment, the liquid removal device 70 comprises an inlet which is covered in a porous material 110 which is used to separate liquid from gas to enable single-liquid phase liquid extraction. A chamber 120 downstream of the porous material 110 is maintained at a slight under pressure and is filled with liquid. The under pressure in the chamber 120 is such that the meniscuses formed in the holes of the porous material prevent ambient gas from being drawn into the chamber 120 of the liquid removal device 70. However, when the porous surface 110 comes into contact with liquid there is no meniscus to restrict flow and the liquid can flow freely into the chamber 120 of the liquid removal device 100. The porous surface 110 extends radially inwardly along the barrier member 12 (as well as around the space). The rate of extraction through the porous surface 110 varies according to how much of the porous material 110 is covered by liquid.

The porous material 110 has a large number of small holes each with a dimension, e.g. a width, such as a diameter, dₕₒₗₑ in the range of 5 to 50 μm. The porous material may be maintained at a height in the range of 50 to 300 μm above a surface from which liquid is to be removed, e.g. the surface of a substrate W. In an embodiment, porous material 110 is at least slightly hydrophilic, i.e. having a contact angle of less than 90°, desirably less than 85° or desirably less than 80°, to the immersion liquid, e.g. water.

It may not always be possible to prevent gas being drawn into the liquid removal device but the porous material 110 will prevent large uneven flows that may cause vibration. Micro-sieves made by electroforming, photoetching and/or laser cutting can be used as the porous material 110. Suitable sieves are made by Stork Veco B. V., of Eerbeek, the Netherlands. Other porous plates or solid blocks of porous material may also be used, provided the pore size is suitable to maintain a meniscus with the pressure differential that will be experienced in use.

During scanning of the substrate W (during which the substrate moves under the barrier member 12 and projection system PS), a meniscus 115 extending between the substrate W and the barrier member 12 may be drawn either towards or away from the optical axis by a drag force applied by the moving substrate. This can lead to liquid loss which may result in: evaporation of the liquid, cooling of the substrate, and consequent shrinkage and overlay errors as described above. Liquid stains may also or alternatively be left behind from interaction between the liquid droplets and resist photochemistry.

Although not specifically illustrated in FIG. 6, the liquid supply system has an arrangement to deal with variations in the level of the liquid. This is so that liquid which builds up between the projection system PS and the barrier member 12 can be dealt with and does not spill. Such a build-up of liquid might occur during relative movement of the barrier member 12 to a projection system PS described below. One way of dealing with this liquid is to provide the barrier member 12 so that it is very large so that there is hardly any pressure gradient over the periphery (e.g., circumference) of the barrier member 12 during movement of the barrier member 12 relative to the projection system PS. In an alternative or additional arrangement, liquid may be removed from the top of the barrier member 12 using, for example, an extractor such as a single phase extractor similar to the extractor 70. An alternative or additional feature is a liquidphobic or hydrophobic coating. The coating may form a band around the top of the barrier member 12 surrounding the opening and/or around the last optical element of the projection system PS. The coating may be radially outward of the optical axis of the projection system. The liquidphobic or hydrophobic coating helps keep the immersion liquid in the space.

In, for example, an apparatus in which two substrate tables or stages are provided in which each one carries a substrate, there exists a difficulty during swap of one substrate table from underneath the projection system to another substrate table underneath the projection system. This is because if the liquid from the liquid supply system is removed prior to swapping the tables then a drying stain may appear on the final element of the projection system. A possible solution to this problem which has been proposed is to provide a shutter member, such as a dummy substrate, which is positionable under the projection system during swapping of substrate tables. In this way the liquid supply system can be kept on during swap of substrates and no drying stains can form. Such a dummy substrate is described, for example, in European Patent Application Publication No. 1,420,299. In another form of shutter member, the second substrate table is brought close to the first substrate table. The two substrate tables are moved simultaneously under the projection system. If the gap between the two substrate tables is small (or at least has a drain underneath it) liquid loss should be minimal. In some instances the substrate table WT has its top surface extended by a protrusion which may be rotatable or retractable, as in the form of a bridge. A bridge can be regarded as a shutter member. Such a arrangement is disclosed in United States Patent Application Publication No. 2007-0216881. In a variation of this form of shutter member, the second table is not a second substrate table, but its surface functions as a shutter member during substrate swap. Such a table may used for measuring and may be called a measuring table. The first or second substrate table is moved back under the projection system when a substrate is available, for example, for exposure. As will be appreciated, the shutter member may in addition or alternatively used in a single substrate table apparatus in order to keep the projection system PS in contact with liquid during, for example, substrate swap on the substrate table.

A challenge with liquid handling systems such as those of FIGS. 5 and 6 is that the immersion system, especially the underside of the barrier member 12, may become contaminated. This may lead to a change in surface contact angle (increase) of the immersion liquid to the surface of the porous member 110 and/or blocking of holes in the porous member 110. A change from liquidphilic to liquidphobic nature of the porous member may lead to a loss in performance of the extractor 70. For example, more gas than usual may be extracted. If the performance of the extractor 70 is reduced, then liquid may leak from the space 11 and be left behind on the substrate surface. This is undesirable. Additionally or alternatively, contamination may be left behind on the top surface of the substrate W or the top surface of the substrate table WT. This is also undesirable as such contamination can find its way into the immersion liquid. Below several ways in which this type of contamination can be cleaned are described.

Particle contamination may predominately comprise photo resist and/or top coat material although other materials could also be present.

Further examples of how a single phase extractors can be used in an immersion hood or liquid confinement system or liquid supply system can be found, for example in European Patent Application Publication No. 1,628,163 and United States Patent Application Publication No. 2006-0158627. In most applications the porous member will be on an underside of the liquid supply system and the maximum speed at which the substrate W can move under the projection system PS is at least in part determined by the efficiency of removal of liquid through the porous member 110.

A single phase extractor may also be used in a two phase mode in which both liquid and gas are extracted (for example, 50% gas, 50% liquid). The term single phase extractor is not intended herein to be interpreted only as an extractor which extracts one phase, but more generally as an extractor which incorporates a porous member through which gas and/or liquid is/are extracted. In an embodiment, two phase extraction may occur without a porous member over the opening. In an embodiment the gas knife (i.e. the gas supply ring 33) may be absent.

The above mentioned single phase extractor can be used in a liquid supply system which supplies liquid to only a localized area of the top surface of the substrate. Furthermore, such an extractor may be used in other types of immersion apparatus. The extractor may be used for an immersion liquid other than water. The extractor may be used in a so-called “leaky seal” liquid supply system. In such a liquid supply system liquid is provided to the space between the final element of the projection system and the substrate. That liquid is allowed to leak from that space radially outwardly. For example, an immersion hood or liquid confinement system or liquid supply system is used which does not form a seal between itself and the top surface of the substrate or substrate table, as the case may be. The immersion liquid may only be retrieved radially outwardly of the substrate in a “leaky seal” apparatus. The comments made in relation to a single phase extractor may apply to other types of extractor, for example, an extractor without a porous member. Such an extractor may be used as a two phase extractor for extracting both liquid and gas.

In the lithographic apparatus, contamination of one or more of the surfaces, for example surfaces of the immersion space, such as a surface of the immersion hood and/or of the substrate table WT, can build up over time if not removed. Such contamination can be comprised of flakes from the top coat particles and/or flakes from the resist. The flakes generally comprise a substituted acrylic polymer, such as a fluorinated polymethylmethacrylate resin. A cleaning fluid may be supplied to a surface in order to remove the contamination present.

In an embodiment, the lithographic apparatus is an immersion type lithographic apparatus. In an embodiment, the fluid supply system is a cleaning fluid supply system.

Embodiments of the present invention relate to a lithographic apparatus comprising a fluid supply system configured to provide a cleaning fluid to a surface to be cleaned. A cleaning fluid according to an embodiment of the invention comprises: from 25 to 98.99 wt % water; from 1 to 74.99 wt % solvent selected from one or more glycol ethers, esters, alcohols and ketones; and from 0.01 to 5 wt % surfactant.

In an embodiment, the water is present in the cleaning fluid in an amount from 25 to 98.99 wt %, such as from 50 to 85 wt % or from 65 to 80 wt %, for example about 75%. In an embodiment, the water is clean, for example the water may be ultra-pure water.

In an embodiment, the solvent is present in the cleaning fluid in an amount from 1 to 74.99 wt %, such as from 15 to 50 wt % or from 20 to 35 wt %, for example about 25 wt %. The solvent should be chosen to have a reasonable match with the contamination that is to be removed. This can be determined, for example, using the Hansen theory (see, for example, Hansen Solubility Parameters, Charles M. Hansen, 2^{nd} edition, CRC press, ISBN 0-8493-7248). Typically, the solvent will have a match, determined using the Hansen theory, of at least 50% (i.e. it will be positioned near the center of the Hansen solubility sphere). The solvent used will also in general be completely mixable in water. In an embodiment, the solvent may have a solubility of more than 10 wt % in water. In an embodiment, the solvent may have a flash point above 38° C., for example above 70° C. or above 93° C.

Glycol ethers for use in the cleaning fluid may include propylene glycolethers, such as propylene glycol methyl ether (PGME), dipropylene glycol methyl ether (DPGME), tripropylene glycol methyl ether (TPGME), propylene glycol ethyl ether (PGEE), propylene glycol normal propyl ether (PGPE), dipropylene glycol normal propyl ether (DPGPE), propylene glycol normal butyl ether (PGBE), dipropylene glycol normal butyl ether (DPGBE), tripropylene glycol normal butyl ether (TPGBE) and propylene glycol tertiary butyl ether (PGTBE); ethylene glycolethers, such as diethylene glycol methyl ether (DEGME), diethylene glycol ethyl ether (DEGEE), diethylene glycolpropyl ether (DEGPE), ethylene glycol butyl ether (EGBE) and diethylene glycol butyl ether (DEGBE); propylene glycol ether acetates, such as propylene glycol methyl ether acetate (PGMEA) and dipropylene glycol methyl ether acetate (DPGMEA), and ethylene glycol ether acetates, such as ethylene glycol butyl ether acetate (EGBEA) and diethylene glycol butyl ether acetate (DEGEA). In an embodiment, the glycol ether may be selected from DEGBE, DEGPE, PGME and DPGME. In an embodiment, the glycol ether is DEGBE.

Esters for use in the cleaning fluid may include compounds which have an ester functionality. Suitable compounds include methyl lactate, ethyl lactate, propyl lactate, butyl lactate, gamma butyrolactone, methyl acetate, ethyl acetate, propyl acetate, butyl acetate, isobutyl acetate, t-butyl acetate and gamma butyrol acetate. In an embodiment, the ester is a dibasic ester. In an embodiment, the ester is ethyl lactate or butyrolactate.

Ketones for use in the cleaning fluid may include cyclohexanone or diacetone alcohol.

Alcohols for use in the cleaning fluid may include methanol, ethanol, propanol, such as isopropanol, t-butyl alcohol, 4-methyl-2-pentanol and cyclohexanol. In general, when alcohols are present in the cleaning fluid, they may be used in an amount of from 1 to 30 wt %.

In an embodiment, the solvent is selected from one or more glycol ethers or esters. In one embodiment, the solvent is selected from one or more glycol ethers.

In an embodiment, the solvent is selected from DEGBE or ethyl lactate. In an embodiment, the solvent is DEGBE.

In an embodiment, the solvent complies with definitions 1 or 2 on the Hazmat Index.

In an embodiment, the solvent does not appear on the California list for carcinogens (State of California Environmental Protection Agency, Office of Environmental Health Hazard Assessment Safe Drinking Water and Toxic Enforcement Act of 1986 Chemicals known to the State to cause Cancer or Reproductive Toxicity, see for example the list dated 1 Jun. 2007 which appears at www.oehha.ca.gov/prop65/prop65_list/files/060107LST.pdf)

In an embodiment, the solvent complies with the requirements of US National Fire Protection Association (NFPA) for safety in the semi-conductor industry. NFPA ratings are normally reported on MSDS sheets.

In an embodiment, the solvent complies with the California list for ozone depletion.

In an embodiment, the surfactant is present in an amount from 0.01 to 5 wt %, such as 0.01 to 2 wt % or 0.1 to 0.5 wt %, for example about 0.3 wt %.

In an embodiment, the surfactant is a hydrophobic surfactant. Hydrophobic surfactants are generally used for removing hydrophobic contaminants. The percentage of hydrophobic PEO groups in a non-ionic surfactant can determine the hydrophobicity. Hydrophobicity can be quantified by measuring the hydrophile-lipophile balance (HLB) of a surfactant. Surfactants with a low HLB are more hydrophobic and tend to make a water in oil emulsion. Surfactants with a high HLB are more hydrophilic and tend to make an oil in water emulsion. For example, the HLB value of F68 is greater than 24, whereas the HLB value of L61 is 1 to 7. L61 is therefore a more hydrophobic surfactant than F68. The HLB value of a surfactant is determined by an analysis of the characteristics of the surfactant. HLB values for common surfactants can be found suitable reference books, such as the Handbook of Pharmaceutical Excipients, 3^{rd} Edition.

In an embodiment, the surfactant has an HLB value lower than 24, desirably lower than 10.

In an embodiment, the surfactant has good wettability. The wettability of a surfactant can be determined by standard wetting tests, for example EN1772. In an embodiment, a surfactant with good wettability will have a value of less than 100 sec, such as less than 80 sec, in the EN1772 test.

In an embodiment, the surfactant has good rinsability. The rinsability of a surfactant can be determined by, for example, measuring the remaining TOC (total organic carbon) level in the outlet of the rinsing water. In an embodiment, a surfactant with good rinsability may result in a content of organic compounds of 5 ppb or less, desirably 1 ppb or less; and/or a particle content of no more than 2 particles having a dimension of 50 nm or greater per ml of rinsing water when used in accordance with embodiments of the present invention. Such a content of organic compounds and/or particle content could be present in the rinsing water at the end of the rinsing process when, for example, rinsing has been performed with ultra pure water for 30 minutes.

In an embodiment, the surfactant has a low foaming characteristic. The foaming of the surfactant can be determined by, for example, the Ross-Miles test [ASTM D1173]. In an embodiment, a surfactant with a low foaming characteristic will have a foam height value in the Ross-Miles test of less than 36.5 cm, such as less than 15 cm or less than 5 cm.

In an embodiment, the term “surfactant” refers to a mixture of surfactants. In an embodiment, a mixture of surfactants is used such that the surfactant will have suitable wettability, rinsability and foaming characteristics.

In an embodiment, the surfactant is selected from one or more nonionic, cationic or anionic surfactants. In an embodiment, the surfactant is selected from one or more nonionic surfactants. In an embodiment, the surfactant comprises a nonionic surfactant which is an ethylene oxide/propylene oxide block copolymer with a molecular weight from 1000 to 3000. A suitable such surfactant is Pluronic® L61 from BASF. In an embodiment, the surfactant comprises a defoaming wetting agent such as Envirogen® AD01 from Air Products.

In an embodiment, the surfactant comprises a mixture of Pluronic® L61 and Envirogen® AD01, such as 0.2 wt % of Pluronic® L61 and 0.1 wt % of Envirogen® AD01.

In an embodiment, the cleaning fluid further comprises a pH adjustment chemical. If present, the pH adjustment can be used to ensure that the pH of the cleaning fluid is from 7 to 10, for example from 8 to 10 or from 9 to 10. Suitable pH adjustment chemicals may include inorganic bases such as sodium hydroxide, potassium hydroxide or a phosphate buffer. Increasing the pH of the solution can decrease the adhesive forces between the contaminant and the surface and may therefore result in more efficient cleaning. However, increasing the pH beyond 10 should in general be avoided since this may lead to damage to parts of the lithographic apparatus, for example the lens.

In an embodiment, the cleaning fluid may be free from nitrogen containing compounds. In an embodiment, the cleaning fluid may be free from ammonia and amines. These compounds are volatile alkalines and may adversely affect the processing of the photo resist.

In an embodiment, the cleaning fluid consists of: from 25 to 98.99 wt % water; from 1 to 74.99 wt % solvent selected from one or more glycol ethers, esters, alcohols and ketones; from 0.01 to 5 wt % surfactant; and, optionally, a pH adjustment chemical. In such an embodiment, the pH of such a cleaning fluid is typically from 7 to 10.

In an embodiment, the cleaning fluid consists of: from 65 to 80 wt % water; from 20 to 35 wt % solvent selected from one or more glycol ethers, esters, alcohols and ketones; from 0.01 to 5 wt % surfactant; and, optionally, a pH adjustment chemical.

In an embodiment, the cleaning fluid consists of: 74.7 wt % water; 25 wt % DEGBE; 0.2 wt % Pluronic® L61; and 0.1 wt % Envirogem® AD01.

In an embodiment, the cleaning fluid consists of: 84.9 wt % water; 15 wt % ethyl lactate; and 0.1 wt % Pluronic® L61.

In general, surfactants are considered to exert a cleaning action by removing contamination from a surface. Surfactants usually comprise a hydrophilic and a hydrophobic part. The hydrophobic part is able to stick to an organic particle and/or surface while the hydrophilic part is orientated to the water. The surfactant can support cleaning in one or more of the following ways: by helping wetting of hydrophobic surfaces; by creating a surface charge thereby causing a repulsive force between particle and surface; by creeping between the particle and the surface (steric hindrance will then push the particle from the surface, reducing Van der Waals and electrostatic forces); and/or by encapsulating suspended dirt particle, effectively protecting the particle to redeposition.

Solvents are generally considered to remove contamination mainly by chemical dissolution. However, the use of pure solvents may be disadvantageous since they may act to cause damage to the lithographic apparatus. In an aspect of the invention, it is desirable that the cleaning fluids do not cause unacceptable levels of damage to the lithographic apparatus. Typically, the cleaning fluids of embodiments of the present invention will cause minimal damage to the apparatus. Materials which can be used in such a lithographic apparatus and which are particularly susceptible to damage by solvents are soft polyurethane hose, which can be used as a flexible hose for the immersion liquid (typically ultrapure water), and Viton O-rings. However, these materials are not used in every lithographic apparatus. If a lithographic apparatus includes polyurethane or Viton (a fluoropolymer), it may be advantageous to select solvents which do not act to damage such materials. A skilled person will be able to select a suitable cleaning fluid based on the presence or absence of materials which are particularly susceptible to damage by components of the cleaning fluid. For example, the solvent will be selected such that it will not damage such materials. In normal use, the cleaning fluids will cause less than a 10% weight change, for example less than a 5% weight change or less than a 1% weight change in the materials to which the cleaning fluid comes into contact. In an embodiment, in an immersion test conducted for 24 hours, or for 12 hours or 6 hours, in which the materials which are susceptible to damage are immersed in the cleaning fluid, there will typically be less than a 10%, for example less than a 5%, weight change in the immersed material. Damage to such materials can also be assessed by a visual check or by measuring the change in a functional property. The cleaning fluids should also cause minimal damage to the coatings of the lens. Typically, hydrophobic coatings are present on the lens element outside the optical path through the lens. The coatings are applied to provide the correct contact angle of the water/air interface at the lens. Examples of such coatings are a SiOₓC_{y}H_{z} coating applied by a plasma process (and which works in a similar manner to Teflon) and a polyurethane-based coating. The cleaning fluids of the invention will typically cause minimal damage to such materials. For example, the contact angle of the coating/lens will typically be changed by less than 10%, for example less than 5%, through use of the cleaning fluid.

In an embodiment, when Viton is present in the lithographic apparatus, if PGMEA is present in the cleaning fluid it will typically be present in an amount of less than 2% PGMEA. In such an embodiment, PGMEA will typically not be used in the cleaning fluid.

In an embodiment, when Viton is present in the lithographic apparatus, if butyl lactone is present in the cleaning fluid it will typically be present in an amount of less than 10% butyl lactone. In such an embodiment, butyl lactone will typically not be used in the cleaning fluid.

In an embodiment, when polyurethane is present in the lithographic apparatus, if PGMEA is present in the cleaning fluid it will typically be present in an amount of less than 20% PGMEA. In such an embodiment, PGMEA will typically not be used in the cleaning fluid.

In an embodiment, when the lens coating is a polyurethane-like coating, if DGMEA is present in the cleaning fluid it will typically be present in an amount of less than 15% DGMEA, more typically less than 5% DGMEA. In such an embodiment, DGMEA will typically not be used in the cleaning fluid.

The cleaning fluids of the present invention are formulated from a mixture of water, solvent, surfactant and, optionally, a pH adjuster and show effective contaminant removal properties. In an aspect of embodiments of the invention, the cleaning fluids cause minimal damage to the lithographic apparatus.

The cleaning fluid may be supplied to the surface to be cleaned by flowing the cleaning fluid over the surface. The flow of cleaning fluid may be continued for any desired length of time, but it is envisaged that it will be for, e.g., up to half an hour, for example up to 5 minutes, up to 10 minutes or even up to 15 minutes would be sufficient to provide a cleaning effect. The cleaning fluid may additionally or alternatively be supplied to the surface and then held for a period of time (e.g. up to 15 minutes, 10 minutes or 5 minutes), before being flushed or pumped out. This process may be repeated one or more times.

Following cleaning, the surface is generally rinsed with ultra-pure water. Rinsing may be performed for a period of, e.g., half an hour, for example up to 15 minutes. Rinsing is intended to remove all traces of the cleaning fluid. After rinsing the levels of contaminants in the system are such that the content of organic compounds is 5 ppb or less, desirably 1 ppb or less and/or the particle content is no more than 2 particles having a dimension of 50 nm or greater per ml of immersion liquid, desirably no more than 0.5 particles having a dimension of 50 nm or greater per ml of immersion liquid.

The cleaning process is generally performed in-line and therefore has minimal disruption to the working of the apparatus. The entire cleaning process may be completed with a maximum down-time of the apparatus of only an hour. Cleaning may therefore be carried out on a relatively frequent basis, for example at the end of every batch, or once per week, or alternatively whenever cleaning is desired. Frequent cleaning has a benefit that contamination levels can be kept to a very low level at all times. If desired, the cleaning process described herein may be carried out in combination with one or more less frequent cleaning processes which may be off-line, such as mechanical spraying or mega-sonic cleaning techniques. However, a potential benefit of the use of the cleaning process and/or cleaning liquid described herein is that the frequency of carrying out such an off-line cleaning method may be reduced or such an off-line technique may be eliminated entirely.

In an embodiment, the entire cleaning process is carried out at room temperature, for example around 25° C.

It is desirable that the cleaning fluid of the present invention does not damage the lithographic apparatus being cleaned. However, in order to prevent any damage occurring, particular parts of the lithographic apparatus can be isolated from the cleaning fluid. This can be achieved using for example to methods described in U.S. Patent Application No. 61/129,871 filed 25 Jul. 2008.

In an embodiment, particular parts of the lithographic apparatus are isolated from the cleaning fluid to prevent damage occurring.

### EXAMPLES

### Cleaning Tests

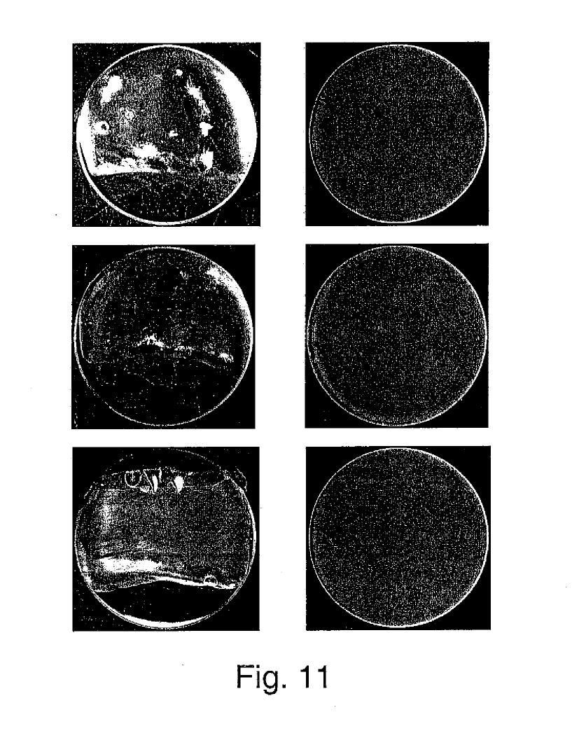

During the cleaning procedure of an immersion hood (IH) the cleaning fluid will stream past the surface of the damper material and through the SPE (single phase extraction) material. Other parts of the immersion hood will not be reached by the cleaning fluid. In order to mimic this behavior, a flow cell was designed that can direct a flow either parallel to a surface or through a SPE material sheet. The experimental set up is shown in FIG. 7.

Two representative contaminants are a topcoat (TCX041 manufactured by JSR Micro) and a resist (TARF 6239 manufactured by TOK). Resist and topcoat materials were sprayed on the samples using an electro spray method. The samples were then cleaned in the flow cell using a variety of soap/solvent mixtures. The results are shown in Tables I and II below.

TABLE I
Cleaning Results

| | | | | | Residue | PRE |
|---|---|---|---|---|---|---|
| Soaps | Additive | Material | Time | PRE topcoat | topcoat | resist |
| TLDR001 | None | SS | 30 | 50-75% | Heavy | 39% |
| (reference) | | | | | | |
| Water | | SS | 30 | 0% | 0 | 0% |
| Ra 2 | None | SS | 30 | Not tested | Heavy | 48% |
| R 111 | None | SS | 30 | Not tested | Light | 43% |
| KS 3053 | None | SS | 30 | 5% | | 39% |
| TLDR001 | None | SS | 10 | Not tested | Heavy | 8% |
| (reference) | | | | | | |
| 5% DEGBE | 0.1% L61 | SS | 30 | Not tested | Heavy | 81% |
| 5% DEGBE | 0.1% F68 | SS | 30 | Not tested | Heavy | 23% |
| TLDR001 | — | LPS | 30 | Not tested | | 44% |
| (reference) | | | | | | |

SS = stainless steel
LPS = laser perforated steel (stainless steel (AISI 316L) sheet in which holes of approx 20 μm have been made using a laser).

From Table I, the following conclusions were drawn: The control experiment with water did not show any particle removal. For top coat cleaning experiments, clear residues after cleaning were measured. The cleaning efficiency (removed matter) was calculated with a correction for the remaining residue. The TARF model contamination only left minor residues. No correction was calculated. The reference soap TOK TLDR001 showed a 50-75% PRE (particle removal efficiency) for topcoat (TCX041) after 30 minutes exposure time. The PRE for TARF 6239 was 39% from SS and 44% from LPS. The difference between these materials was within the accuracy of the determination. It shows that the influence of the cleaning power is dominant over the influence of the substrate. Therefore, only a limited number of tests on LPS are desired. Other commercial soap mixtures did not show improved compared to TLDR A001,

TABLE II
Cleaning Results

| | | | | PRE | Residue | PRE | |
|---|---|---|---|---|---|---|---|
| Solvents | Additive | Material | Time | topcoat | topcoat | resist | Remarks |
| 50% | 0.1% L61 | SS | 30 | 100% | None | 99% | Residues |
| DEGBE | | | | | | | and stains |
| 25% | 0.1% L61 | SS | 30 | — | Heavy | 90% | for both |
| DEGBE | | | | | | | tests |
| 15% EL | 0.1% L61 | SS | 30 | 99% | Extreme | 100% | (possibly |
| | | | | | residue | | from |
| 15 GBL | 0.1% L61 | SS | 30 | — | Heavy | 58% | solvent) |
| 25% | 0.2% L61 + | SS | 30 | — | Very light | 99% | |
| DEGBE | 0.1% | | | | >90% matter | | |
| | AD01 | | | | removed | | |
| 25% | 0.2% L61 + | SS | 10 | — | Light | 60% | |
| DEGBE | 0.1% | | | | | | |
| | AD01 | | | | | | |
| 25% | 0.2% L61 + | LPS | 30 | 100% | None | 95% | |
| DEGBE | 0.1% | | | | | | |
| | AD01 | | | | | | |
| 25% | 0.2% L61 + | LPS | 30 | No test | | 100% | |
| DEGBE | 0.1% | | | | | | |
| | AD01 | | | | | | |
| 25% | 0.2% L61 + | LPS | 30 | No test | | 95% | |
| DEGBE | 0.1% | | | | | | |
| | AD01 | | | | | | |

SS = stainless steel
LPS = laser perforated steel (stainless steel (AISI 316L) sheet in which holes of approx 20 μm have been made using a laser).

From Table II, the following conclusions were drawn: The best PRE is obtained with 50% DEGBE in a solution with 50% UPW and an exposure time of 30 minutes. The PRE is 100% both for topcoat (TCX041) and resist (TarF6239) from damper material as well as SPE material. No residues are observed. DEGBE is also tested with a lower concentration of 25%. The best performing surfactant mix contains 0.2% Pluronic surfactant and 0.1% Envirogem AD01. The solvent GBL was ess desirable, because of a low PRE for TarF 6239. With ethyl lactate (EL), a relative heavy residue was found. It is thought this might be due to the solvent itself and could be removed by increasing pH to 7-10.

In conclusion, the following cleaning mixtures show (potentially) the best solvent cleaning results: 1) DEGBE 25% 0.2% L61+AD01; and 2) 15% ethyl lactate +0.1% L61. The cleaning mixtures may be improved be using a higher pH and using a surfactant mix with higher detergency.

The washing and rinsing sequence may be tuned to reduce/eliminate the residue left. Residues that are adhered in such a manner that they are not removed by the washing and rinsing sequence may not have a detrimental effect upon the working of the apparatus.

### Damage Tests

For the cleaning fluids of the present invention, it is desired to limit the damage that could be caused by the fluid to the lithographic apparatus. Two of the most sensitive materials which can be used in such an apparatus are soft polyurethane (PUR) hose and Viton, which is a fluoroelastomer that is used to manufacture, for example, O-rings. A 24-hour immersion test was performed on these materials using different concentrations of solvent. In general, the contact time for cleaning is approximately 30 minutes. The 24-hour immersion test thus represents a worst case scenario.

The results are shown in FIGS. 8A and 8B.

From these experiments, it can be concluded that: Solvents (mixtures) which showed a weight increase of more than 10% if the sensitive materials in the 24-hour immersion test may be too aggressive to be used. For DMSO this was the case even at diluted concentrations. Also a relatively mild solvent like 4-methyl-2-pentanol displayed a weight change that is close to 10%. It is likely that other concentrated solvents in general (which are stronger than 4-methyl-2-pentanol) may not be used without adding water.

An appropriate concentration of water in the cleaning fluid was thus determined.

For the soft PUR tubing and Viton, 24-hour absorption and desorption curves were also determined and the results are shown in FIGS. 9A and 9B. Again, since the contact time of the cleaning fluids will in general be approximately 30 minutes, the 24-hour curves are intended to illustrate a worst case scenario.

For the TOC level under the lens, the materials that are upstream of lens are of importance. The combination of the exposed area and desorption rate (mg/cm² hour) can be used to provide an estimation of the actual ppb levels after cleaning (due to desorption only) and are shown in the following table.

TABLE III
Total Organic Carbon Levels

| | TOC under the |
|---|---|
| | lens after 1 hour |
| | rinsing |
| | (excluding PFA) |
| | ppb TOC |
| Solvent | |
| Ethyl lactate 15% | 1.6 |
| Ethyl lactate 30% | 2 |
| Butyrolactone 15% | 2.3 |
| Butyrolactone 30% | 10 |
| DEGBE 25% | 2.6 |
| DEGBE 50% | 4.5 |
| Reference | |
| TLDR001 | 1.1 |

From the results listed in Table ITT, the following can be concluded: The impact of PFA tubing could not be estimated since the absorption of the material is below the used detection limit of the method (weight change <0.001%/hour). However, the supply line will generally contain more than 25 meter of PFA tubing (approximate 2500 cm²), such that even low desorption rates can effect the TOC level. The Viton is a sensitive material (relative high desorption values) in the supply line but it has only a limited surface area (<1 cm²) and is therefore of less importance for the TOC level. The Fluran hose shows an intermediate desorption rate. This can be an important contributor to the TOC level. The PUR tubing is generally attached to the outlet of the immersion hood so does not affect the UPW under the lens. It will have effect on the TOC level of the waste drain. Normally the requirements for TOC levels in waste are less critical but depend on local regulations for waste water disposal.

Measurement TOC Levels after Cleaning Due to Desorption

In a rinse experiment 25 m PFA and 1 m Fluran tubing were exposed to the following cleaning fluid: 25% DEGBE with 0.2% L61 and 0.1% AD01. After a 30 minute exposure the tube was emptied and connected to a Sievers ppt TOC monitor.

To increase the detection limit of the test the UPW flow was kept low: 0.2 l/min. In this way the desorbed organics are present in a smaller volume and therefore a higher concentration is to be expected. Under standard conditions the flow velocity in the UPW supply line is approximate 1.5 liter/min. The length of the tube was chosen to be realistic (25 m for PFA) or longer for Fluran (1 m instead of 0.2 in) to increase the detection limit.

All measured TOC levels were corrected for a flow rate of 1.5 liter/min and the realistic length of tubing. The results are shown in FIG. 10.

From the results, the following conclusions can be drawn: The concentration of the reference mixture shows a TOC level of 7-10 ppb after 30 minutes (for PFA hose). The complete rinsing of the PFA test hose (TOC <1 ppb) takes about 3 h. The 25% DEGBE mix shows a level of 2-3 ppb after 30 minutes rinsing. Rinse out takes to <1 ppb level takes 1.5 hour. This is better compared to the TOK TLDR A001 reference mix. The Fluran hose (<1 ppb after 0.25 hour) has a limited effect on the TOC levels after cleaning.

The total TOC levels under practical conditions are also dependent on the factors mentioned below, which can considerably influences the rinsing process. The influence of 3 dimensional design of supply line, ILCC and IH: O-rings, valves and the like. The difference in wetted surface area between a cleaning fluid (with a low surface tension) and UPW which has a high surface tension. The possibility to empty the supply line (wet to dry cycle). This can have an increased efficiency for the rinsing out of the chemicals.

### Measurement of Mechanical Damage of Tubing

To determine whether the mechanical properties of the Fluran (input side) and soft PUR hose (output side) change due to solvent uptake, an immersion test was performed. After 1 hour and 24-hour immersion the weight increase and the shear-modulus of the tubings were measured. The results of the test are given in Table IV below.

TABLE IV
Mechanical Properties

| | | | G′- | Change |
|---|---|---|---|---|
| | | time | modulus | compared to |
| Material | Solvent | hour | [MPa] | reference |
| Fluran | Pre-wetted in | 72 | 4.0 ± 0.18 | |
| | UPW | | | |
| | (reference) | | | |
| Soft | Pre-wetted in | 72 | 19.0 ± 1.4 | |
| PUR | UPW | | | |
| | (reference) | | | |
| Fluran | DEGBE 25% | 23 | 3.7 ± 0.46 | −7.5 |
| Soft- | DEGBE 25% | 23 | 13.4 ± 0.51 | −29.5 |
| PUR | | | | |

The relationship between the Shear modulus G′ and Elastic modulus E: is given by the following formula (meaning that the G-modulus change is directly proportional to the E-modulus change):

$${G}^{′} = \frac{E}{2 ( 1 + v )}$$

The following was concluded from Table IV: Fluran G-modulus change is less than 10% for the 24-hour worst case test. Viton G-modulus change is 30% for the 24-hour worst case test.

It is estimated that a short exposure (30 minutes) would lead to only small change.

### Testing of the Lens Coating

Test samples with a coating of a polyurethane-like coating and a silicone-like coating of formula SiOₓC_{y}H_{z} were immersed either for 24-hour in the 25% DEGBE mix cleaning fluid or for 24 hour in UPW. Samples were evaluated using optical microscopy and SEM and compared to samples in as received condition.

The following side seal coated samples were tested: polyurethane-like side seal coating on quartz; and silicone-like/Ta₂O₅ coating on quartz.

The SEM images taken are shown in FIG. 11.

The glass substrates of the polyurethane-like coated samples were covered partly with a thin hazy coating. Some places on the samples showed a cracked TiO₂ undercoat and a sticky (coating) material of irregular thickness.

The SEM photos showed a large change in the adhesion of the coating. Some of the coating was starting to peel off. The following was concluded: Degradation of the coating was shown after a 24-hour immersion test using DEGBE. However, this test is a worst case scenario. Degradation may also in part be due to the quality of the sample tested.

The silicone-coated material consisted of a 25 mm diameter quartz substrate single side homogeneously coated. The change in structure of the coating was detected by measurement of SEM before and after immersion by SEM. No influence of the DEGBE solution on the silicone coating was detected. The 24-hour DEGBE test was therefore passed.

In an aspect, there is provided a lithographic apparatus comprising a fluid supply system configured to provide a cleaning fluid to a surface to be cleaned, the cleaning fluid comprising from 25 to 98.99 wt % water, from 1 to 74.99 wt % solvent selected from one or more glycol ethers, esters, alcohols and ketones, and from 0.01 to 5 wt % surfactant. Optionally, the surfactant is a hydrophobic surfactant. Optionally, the water is present in the cleaning fluid in an amount from 50 to 85 wt %. Optionally, the water is present in the cleaning fluid in an amount from 65 to 80 wt %. Optionally, the solvent is present in the cleaning fluid in an amount from 15 to 50 wt %. Optionally, the solvent is present in the cleaning fluid in an amount from 20 to 35 wt %. Optionally, the solvent is selected from one or more glycol ethers or esters. Optionally, the solvent is DEGBE. Optionally, the surfactant is present in an amount from 0.01 to 2 wt %. Optionally, the surfactant is selected from one or more nonionic surfactants. Optionally, the surfactant comprises a nonionic surfactant comprising an ethylene oxide/propylene oxide block copolymer having a molecular weight from 1000 to 3000. Optionally, the cleaning fluid comprises from 65 to 79.99 wt % water, from 20 to 34.99 wt % solvent selected from one or more glycol ethers, esters, alcohols and ketones, from 0.01 to 5 wt % surfactant; and, optionally a pH adjustment chemical. Optionally, the cleaning fluid further comprises a pH adjustment chemical. Optionally, the pH of the cleaning fluid is from 7 to 10. Optionally, the pH of the cleaning fluid is from 8 to 10. Optionally, the pH of the cleaning fluid is from 9 to 10. Optionally, the cleaning fluid consists essentially of 74.7 wt % water, 25 wt % DEGBE, 0.2 wt % Pluronic® L61, and 0.1 wt % Envirogem® AD01. Optionally, the cleaning fluid consists essentially of 84.9 wt % water, 15 wt % ethyl lactate, and 0.1 wt % Pluronic® L61. Optionally, the lithographic apparatus is an immersion type lithographic apparatus. Optionally, the fluid supply system is a cleaning fluid supply system.

In an aspect, there is provided a method of cleaning a surface in a lithographic apparatus, the method comprising: supplying a cleaning fluid to the surface to be cleaned, the cleaning fluid comprising from 25 to 98.99 wt % water, from 1 to 74.99 wt % solvent selected from one or more glycol ethers, esters, alcohols and ketones, and from 0.01 to 5 wt % surfactant. Optionally, the cleaning fluid is as defined above.

In an aspect, there is provided a use of a cleaning fluid is as defined above to clean a lithographic apparatus.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A lithographic apparatus comprising:
a projection system configured to project a patterned beam of radiation onto a target portion of a substrate; and
a fluid supply system configured to provide a cleaning fluid to a surface of the lithographic apparatus to be cleaned, the cleaning fluid comprising
from 25 to 98.99 wt % water;
from 1 to 74.99 wt % solvent selected from one or more glycol ethers, esters, alcohols and ketones; and
from 0.01 to 5 wt % surfactant.

2. The apparatus according to claim 1, wherein the surfactant is a hydrophobic surfactant.

3. The apparatus according to claim 1, wherein the water is present in the cleaning fluid in an amount from 50 to 85 wt %.

4. The apparatus according to claim 3, wherein the water is present in the cleaning fluid in an amount from 65 to 80 wt %.

5. The apparatus according to claim 1, wherein the solvent is present in the cleaning fluid in an amount from 15 to 50 wt %.

6. The apparatus according to claim 5, wherein the solvent is present in the cleaning fluid in an amount from 20 to 35 wt %.

7. The apparatus according claim 1, wherein the solvent is selected from one or more glycol ethers or esters.

8. The apparatus according to claim 1, wherein the solvent is DEGBE.

9. The apparatus according to claim 1, wherein the surfactant is present in an amount from 0.01 to 2 wt %.

10. The apparatus according to claim 1, wherein the surfactant is selected from one or more nonionic surfactants.

11. The apparatus according to claim 1, wherein the surfactant comprises a nonionic surfactant comprising an ethylene oxide/propylene oxide block copolymer having a molecular weight from 1000 to 3000.

12. The apparatus according to claim 1, wherein the cleaning fluid comprises:
from 65 to 79.99 wt % water;
from 20 to 34.99 wt % solvent selected from one or more glycol ethers, esters, alcohols and ketones;
from 0.01 to 5 wt % surfactant; and, optionally
a pH adjustment chemical.

13. The apparatus according to claim 1, wherein the cleaning fluid further comprises a pH adjustment chemical.

14. The apparatus according to claim 13, wherein the pH of the cleaning fluid is from 7 to 10.

15. The apparatus according to claim 14, wherein the pH of the cleaning fluid is from 8 to 10.

16. The apparatus according to claim 15, wherein the pH of the cleaning fluid is from 9 to 10.

17. The apparatus according to claim 1, wherein the cleaning fluid consists essentially of:
74.7 wt % water;
25 wt % DEGBE;
0.2 wt % Pluronic® L61; and
0.1 wt % Envirogem® AD01.

18. The apparatus according to claim 1, wherein the cleaning fluid consists essentially of:
84.9 wt % water;
15 wt % ethyl lactate; and
0.1 wt % Pluronic® L61.

19. The apparatus according to claim 1, wherein the lithographic apparatus is an immersion type lithographic apparatus.

20. The apparatus according to claim 1, wherein the fluid supply system is a cleaning fluid supply system.

21. A method of cleaning a surface in a lithographic apparatus, the method comprising:
supplying a cleaning fluid to the surface to be cleaned, the cleaning fluid comprising
from 25 to 98.99 wt % water;
from 1 to 74.99 wt % solvent selected from one or more glycol ethers, esters, alcohols and ketones; and
from 0.01 to 5 wt % surfactant.
